(19) United States
(12) Patent Application Publication
(10) Pub. No.: US 2021/0151894 A1
(43) Pub. Date: May 20, 2021

(54) NOVEL HOLLOW LIGHT WEIGHT LENS STRUCTURE

(71) Applicant: Arizona Board of Regents on Behalf of The University of Arizona, Tucson, AZ (US)

(72) Inventors: Hao Xin, Tucson, AZ (US); Min Liang, Tucson, AZ (US)

(21) Appl. No.: 16/622,811

(22) PCT Filed: Jun. 15, 2018
(86) PCT No.: PCT/US2018/037885

§ 371 Date: Dec. 13, 2019

Related U.S. Application Data
(60) Provisional application No. 62/521,098, filed on Jun. 16, 2017.

(51) Int. Cl. H01Q 15/10

(52) U.S. Cl. CPC H01Q 15/10

(57) ABSTRACT

A hollow light-weight, low-cost, and high-performance 3D Luneburg lens structure using partially-metalized thin film, string, threads, fiber or wire base metamaterial to implement the continuously varying relative permittivity profile, characteristic of Luneburg lens structures, is disclosed. The hollow light-weight lens structure is based on the effective medium approach and may be implemented by a number of means. Further, most of the volume of the lens structure is free-space, thus the weight of the lens is significantly less than conventional 3D Luneburg lens structures of the same dimensions.

### CROSS REFERENCE

This application claims priority to U.S. Provisional Patent Application No. 62/521,098, filed Jun. 16, 2017, the specifications of which are incorporated herein in their entirety by reference.

### FIELD OF THE INVENTION

The present invention relates to the design and fabrication of a hollow 3D lens structures, more specifically, the design and fabrication of a hollow light weight Luneburg lens structure using partially-metalized thin film, string, threads, fiber or wire-based metamaterial.

### BACKGROUND OF THE INVENTION

The Luneburg lens is an attractive gradient index device for multiple beam tracking because of its high gain, broadband behavior, and ability to form multiple beams. Every point on the surface of a Luneburg lens is the focal point of a plane wave incidents from the opposite side. The permittivity distribution of a Luneburg Lens is given by:

$${ɛ}_{r} = 2 - {( \frac{r}{R} )}^{2} ,$$

where εᵣ is the permittivity, R is the radius of the lens and r is the distance from the location to the center of the lens. In current technologies, a 3 dimensional (“3D”) printed Luneburg lens structure is constructed by controlling the filling ratio between the polymer composing the lens and air. Most of the lens structure is typically made of polymer; therefore, its weight increases significantly when the size of the lens becomes larger. Further, fabrication costs associated with current technologies are typically high for larger lens size. The present invention features a hollow light weight, low-cost, and high performance 3D Luneburg lens structure using partially-metallized thin film, string, threads, fiber or wire-based metamaterial.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

The present invention features a method for fabricating a hollow light-weight 3D lens structure operable in the RF frequency range. In some embodiments, partially-metalized thin film or wire is used to implement the continuously varying relative permittivity profile characteristic of the lens structures. In alternate embodiments, wire base dielectrics are utilized to implement the relative permittivity profile.

One of the unique and inventive technical features of the present invention is the use of the effective medium approach to increase the amount of free-space comprising the volume of the present 3D Luneburg lens structure, relative to conventional 3D Luneburg lenses. Without wishing to limit the invention to any theory or mechanism, it is believed that the technical feature of the present invention advantageously provides for a hollow lighter weighing lens structure and, as less material is required, a higher fabrication rate. None of the presently known prior references or work has the unique inventive technical feature of the present invention.

### BRIEF DESCRIPTION OF THE DRAWINGS

The features and advantages of the present invention will become apparent from a consideration of the following detailed description presented in connection with the accompanying drawings in which:

FIG. 1A is an illustration of the principal of the hollow structure lens.

FIG. 1B is an illustration of metallization of imaginary cell and the degree of metallization according to its junction location.

FIG. 1C is a photo of a center cross-section of a hollow light-weight Luneburg lens structure.

FIG. 1D is a photo of the hollow light-weight Luneburg lens structure of the present invention.

FIG. 2A shows an illustration of the unit cell structure of the partially-metallized wire-based hollow light-weight Luneburg lens structure having a unit cell size of 5 mm.

FIG. 2B shows an illustration of the unit cell structure of the partially-metallized string-based hollow light-weight Luneburg lens structure having a unit cell size of 10 mm. The dielectric wire, having a copper coating, has a diameter of 0.5 mm and a dielectric constant of 2.8. Metal traces include all three axes (X, Y, and Z).

FIG. 2C shows an illustration of an alternate embodiment of the unit cell structure of the partially-metallized string-based hollow light-weight Luneburg lens structure having a unit cell size of 5 mm. The dielectric wire has a thickness of 0.14 mm and a permittivity 2.5. The metal traces have a conductivity of 1×10⁻⁵ S/m to emulate the conductive ink before sintering. Metal traces including all three axes (X, Y, and Z).

FIG. 3A shows an example of a 25-layer partially-metallized string-based hollow light-weight Luneburg lens structure having a plurality of unit cell structures, each as detailed in FIG. 2A.

FIG. 3B shows an example of a 25-layer partially-metallized string-based hollow light-weight Luneburg lens structure having a plurality of unit cell structures, each as detailed in FIG. 2B.

FIG. 3C shows an example of a 25-layer partially-metallized string-based hollow light-weight Luneburg lens structure having a plurality of unit cell structures, each as detailed in FIG. 2C.

FIG. 4 shows an example of the metal length distribution for layer 0 of the unit cell of FIG. 2B.

FIG. 5A shows unit cell simulations and effective permittivity for the unit cell structure of FIG. 2A.

FIG. 5B shows unit cell simulations and effective permittivity for the unit cell structure of FIG. 2B.

FIG. 5C shows unit cell simulations and effective permittivity for the unit cell structure of FIG. 2C.

FIG. 6A shows a graph of the simulated relationship between metal length and effective permittivity as detailed in FIG. 5A.

FIG. 6B shows a graph of the simulated relationship between metal length and effective permittivity as detailed in FIG. 5B.

FIG. 6C shows a graph of the simulated relationship between metal length and effective permittivity as detailed in FIG. 5C.

FIG. 7 shows the measured the plane containing the magnetic field vector (“H-plane”) radiation pattern of the light-weight Luneburg lens of FIG. 1B.

FIG. 8 shows the gain and H-plane half-power beamwidth (“HPBW”) at different frequencies from 8 to 12 GHz of the light-weight Luneburg lens of FIG. 1B.

FIG. 9 shows the measured plane containing the electric field vector (“E-plane”) radiation pattern of the light-weight Luneburg lens of FIG. 1B.

FIG. 10 shows the gain and E-plane HPBW at different frequencies from 8 to 12 GHz of the light-weight Luneburg lens of FIG. 1B.

FIG. 11 shows two additional approaches to constructing the partially-metallized plate-based hollow light-weight Luneburg lens structure.

### DETAILED DESCRIPTION OF THE INVENTION

In a broad embodiment, the present invention features a hollow structure lens (100) with radius R (102) comprising:
a) a three-dimensional scaffold (104) having multiple junctions (110); wherein each junction inside the lens is at least partially metalized (170), (180) to a degree;
b) a center point (120) of the hollow structure lens (100) formed by the three-dimensional scaffold (104); and
c) an outer edge (130) of the hollow structure lens (100) formed by the three-dimensional scaffold (104);
   wherein the three-dimensional scaffold (104) forms the junctions (110) inside the lens;
   wherein the junctions (110) are positioned from the innermost of the lens at or near the center point (120) toward the outermost of the lens at or near the edge (130) of the lens (100);
   wherein each junction (110) resides in an imaginary unit cell (140); each imaginary unit cell is at least partially metalized to the degree of the at least partially metalized junction (170) that resides within each imaginary unit cell (140);
   wherein the further the partially metalized junction (180) is away from the center point (120), the less the degree of the metallization of the imaginary cell (140).

In some embodiments, the degree of the metallization of the imaginary cell can be calculated by a full-wave finite-element simulation software, to produce a permittivity of the imaginary cell being εᵣ wherein

$${ɛ}_{r} = 2 - {( \frac{r}{R} )}^{2} ,$$

wherein r is the distance of the junction to the center point (120).

In some embodiments, the at least partially metalized junction is constructed from a at least partially metalized thin film (180), thread, fiber, wire or string (190).

In some embodiments, a metal etch, or an ink jet print can be used to metalize a metamaterial substrates to make the partially metallized junctions (180), (190).

In some embodiments, the scaffold (104) is constructed by stacking layers of the at least partially metalized thin films, wires, threads, fiber or strings in a way that each layer crisscross to each other to produce the hollow structure lens (100).

In some embodiments, the crisscross layers is fixed on to a support frame (200).

In some embodiments, the support frame is 3D printed.

In some embodiments, the scaffold and partially metalized junctions is constructed by interlocking at least partially metalized thin film plates (210), (220); wherein interlocking means at least 2 plates intersect with each other and form the junction (110); wherein the at least partially metalized plates form at least partially metalized junctions when they interlock.

In some embodiments, most of the space is a free space due to 3D scaffold structure.

In some embodiments, the hollow structure lens (100) is a Luneburg lens.

In a broad embodiment, the present invention features a method for fabricating a hollow light-weight lens structure, operating in Radio Frequency (RF), by utilizing effective medium approximations of partially-metalized metamaterial thin film, wire, threads, fiber or string, the method comprising
a) etching a series of patterns, descriptive of a continuously varying relative permittivity characteristic of the light-weight lens structure, on a series of layers of a dielectric substrate with conductive ink;
b) providing a support frame;
c) assembling the light-weight lens structure by stacking the series of layers of the dielectric substrate; and
d) securing said stacking with the set of support frames.

In a broad embodiment, the present invention features the lens is a Luneburg lens.

In a broad embodiment, the present invention features a hollow light-weight lens structure, operating in RF frequency, by utilizing effective medium approximations of partially-metalized dielectric thin film, wire, string, threads or fiber to realize a gradient index requirement of Luneburg lens structures, the method comprising constructing a set of design patterns, representative of a continuously varying relative permittivity characteristic of the light-weight Luneburg lens structure, with a plurality of partially-metallized strings, wherein each partially-metallized string comprises a metallic coating disposed on a metamaterial.

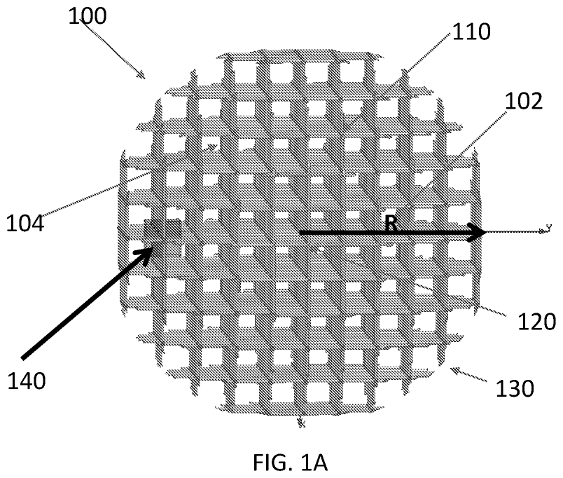

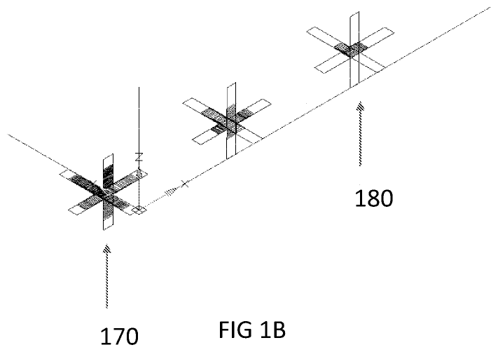

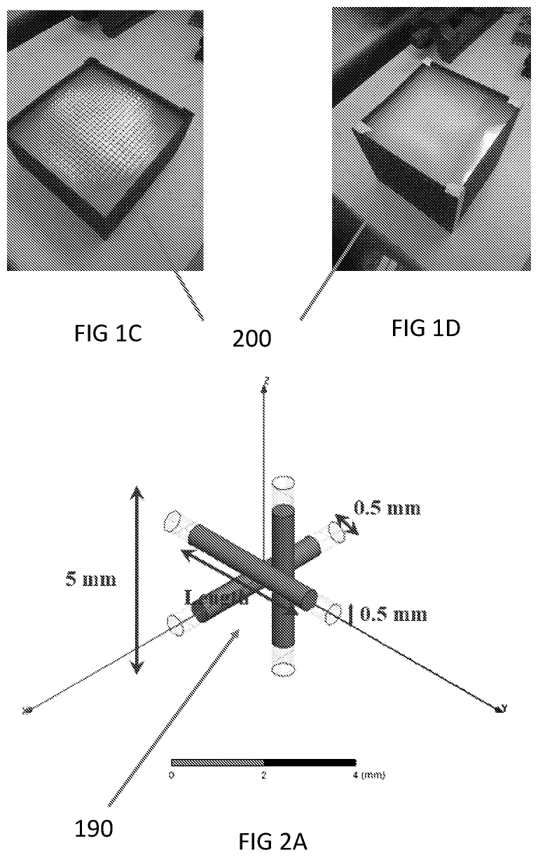

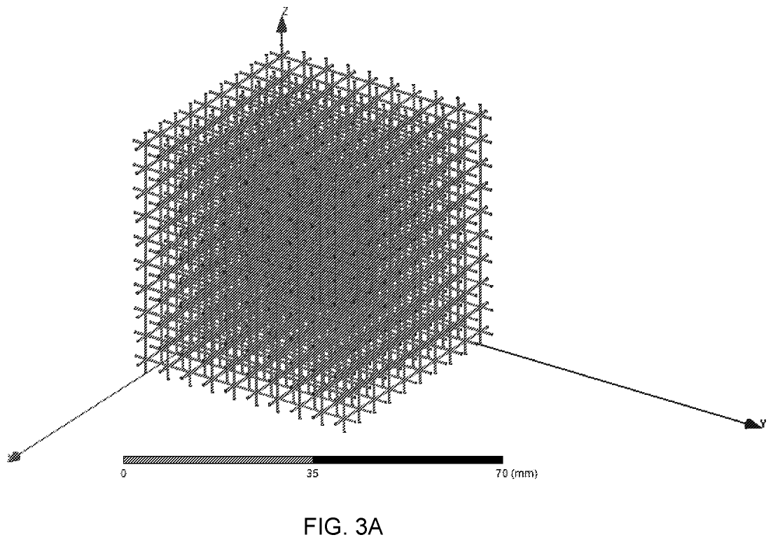

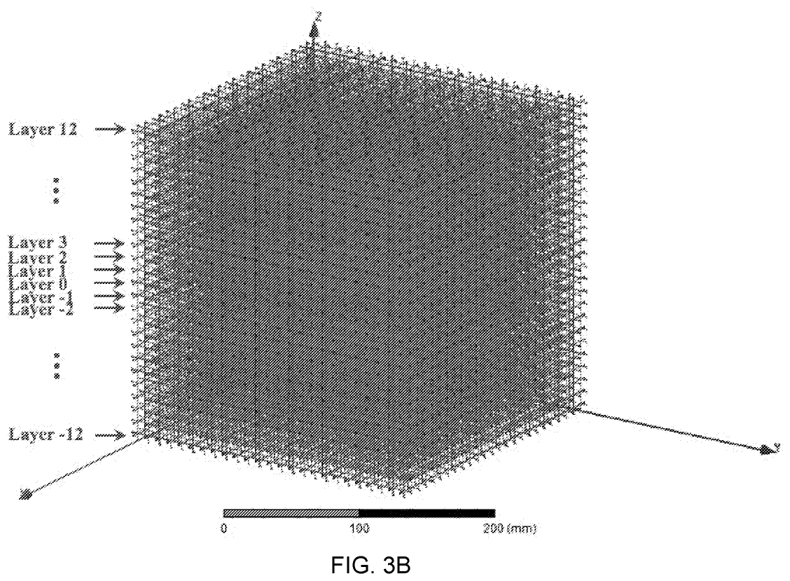

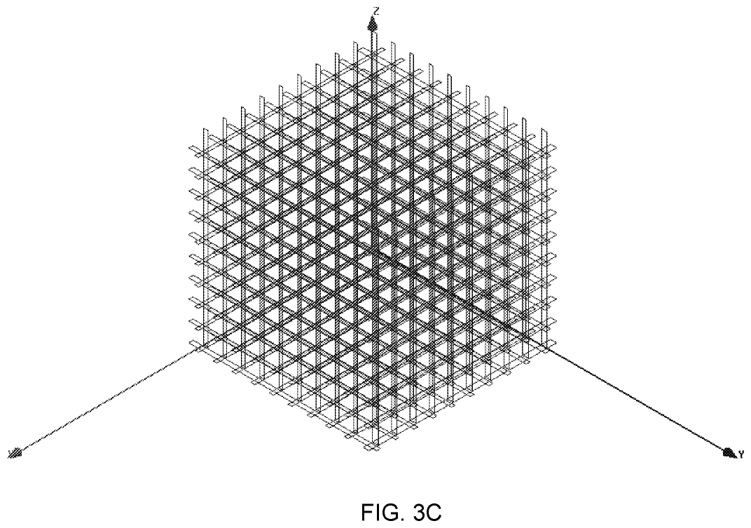

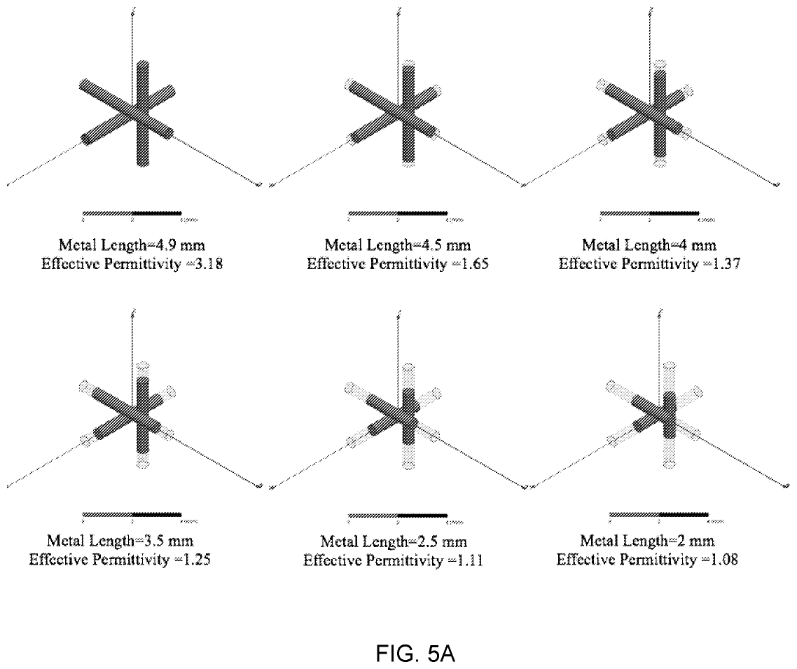

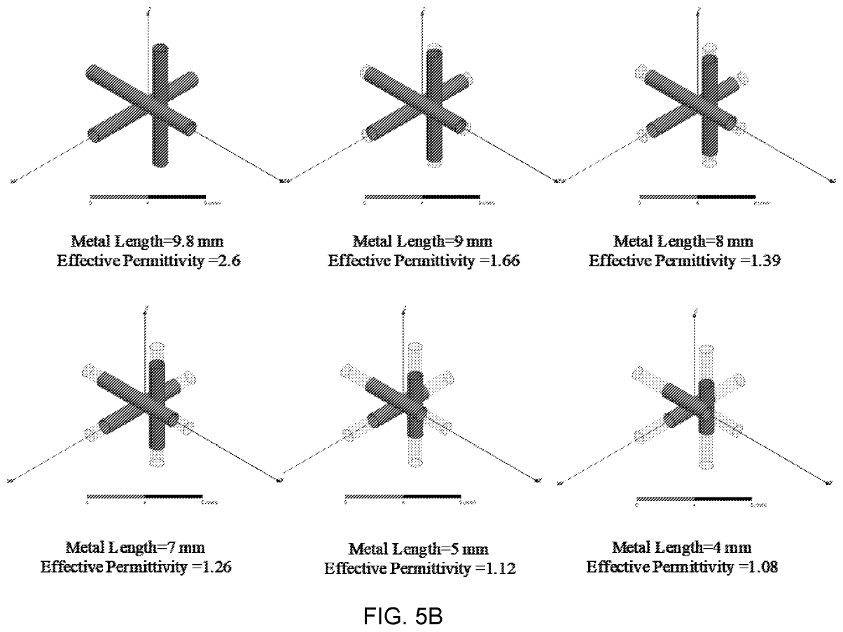

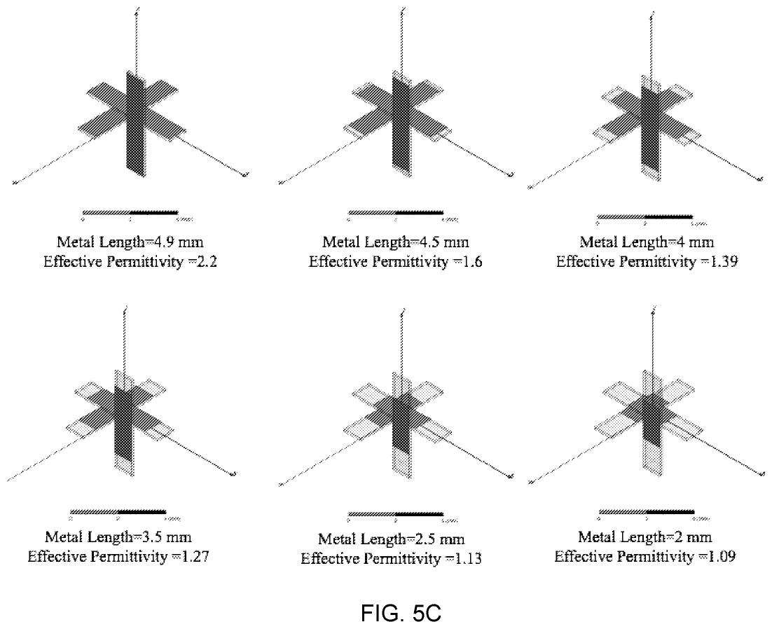

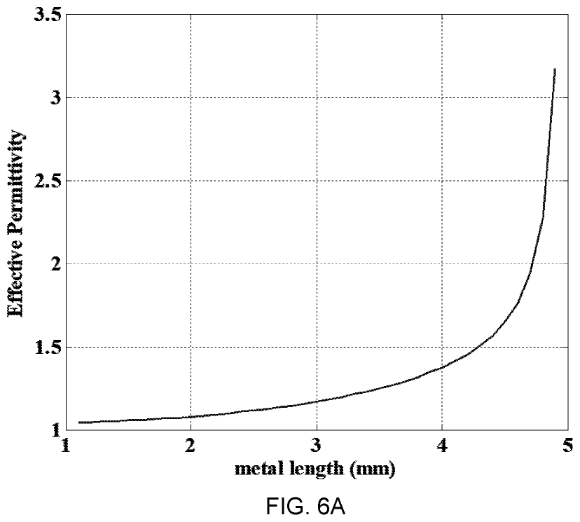

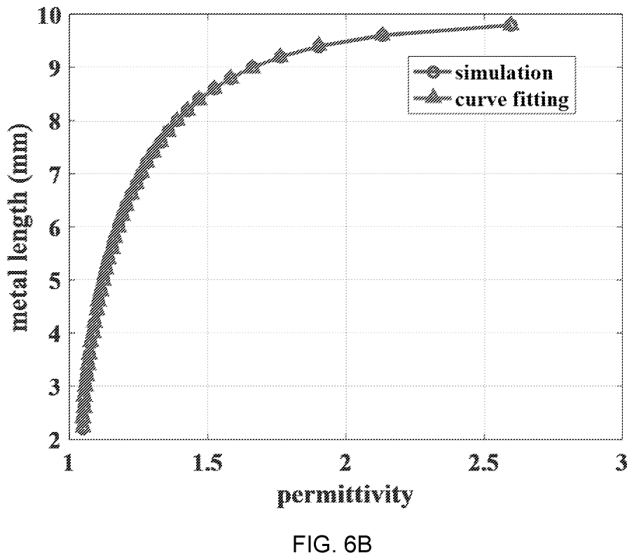

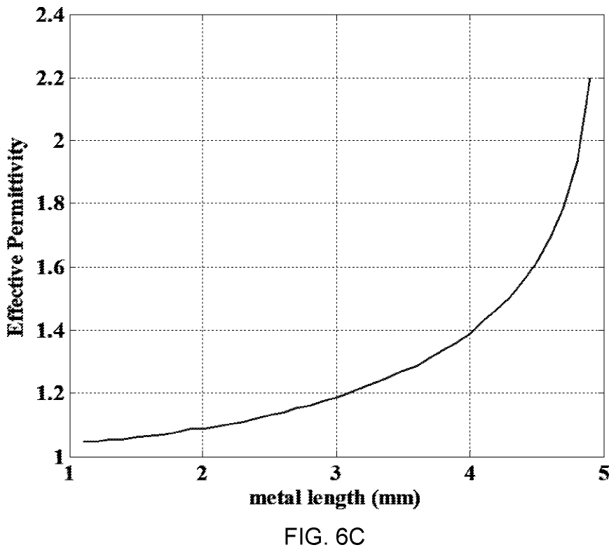

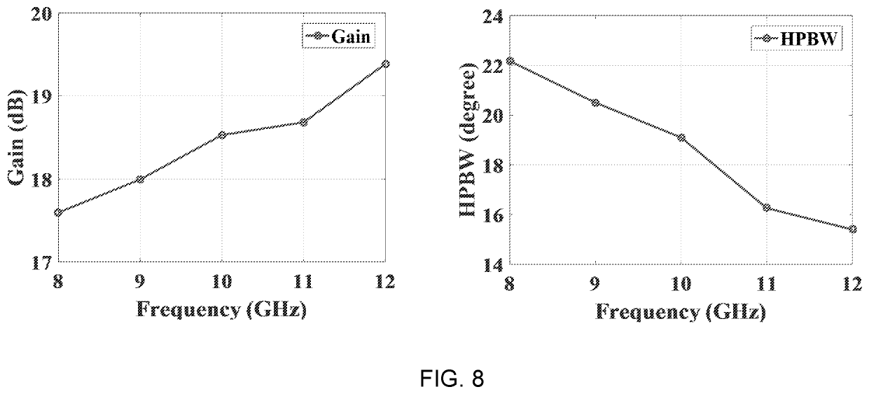

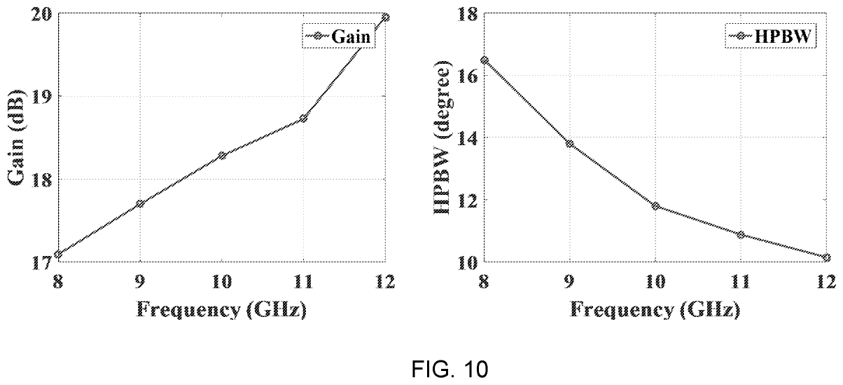

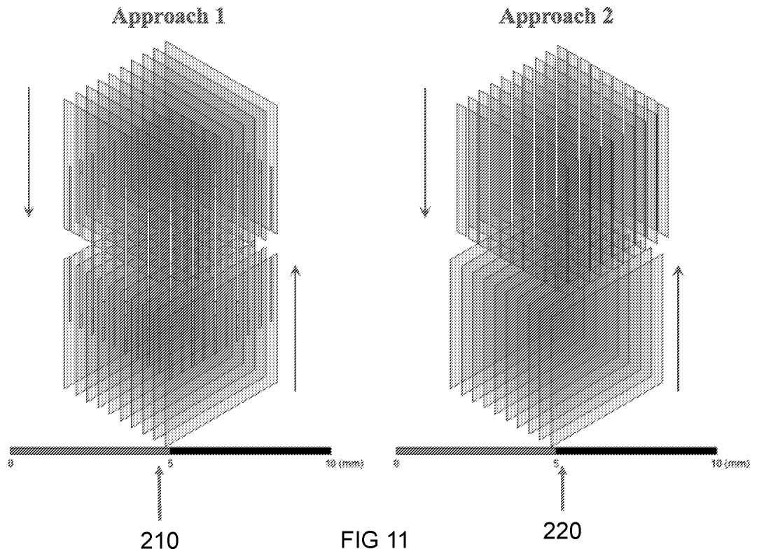

Referring now to FIGS. 1A-11, the present invention features a method for fabricating a hollow light-weight Luneburg lens structure operable in the RF frequency range. The light weight of the lens structure, (relative to conventional Luneburg lens structures), is accomplished by utilizing effective medium approximations of partially-metalized dielectric thin film, wire or string to increase an amount of free-space comprising the volume of the light-weight Luneburg lens structure. In some embodiments, the method comprises etching a series of patterns, descriptive of a continuously varying relative permittivity characteristic of the light-weight Luneburg lens structure, onto a series of layers of a dielectric substrate with conductive ink. In further embodiments, a set of support frames, composed of polymer, are printed via a 3-D printer. The light-weight Luneburg lens structure may be assembled by stacking the series of layers of the dielectric substrate, and securing said stacking with the set of support frames.

A conventional 3D printed Luneburg lens structure having the same dimensions of the present light-weight Luneburg lens structure has a weight of 500 g, while the weight of the light-weight Luneburg lens structure is less than 20 g (excluding the set of supporting frames). Moreover, the majority of the weight of the light-weight Luneburg lens structure is a result of the weight of the set of supporting frames, which is about 180 g. By replacing the frames with other lighter materials (e.g., foam), the weight of the light-weight Luneburg lens structure may be further decreased.

In an alternate embodiment, the continuously varying relative permittivity characteristic of the light-weight Luneburg lens structure is realized by employing a plurality of partially-metallized strings. Each partially-metallized string may comprise a metallic coating disposed on a dielectric substrate. Examples of methods for coating the dielectric substrate with the metallic portion include, but are not limited to: conductive ink printing, copper painting, and electronic platting.

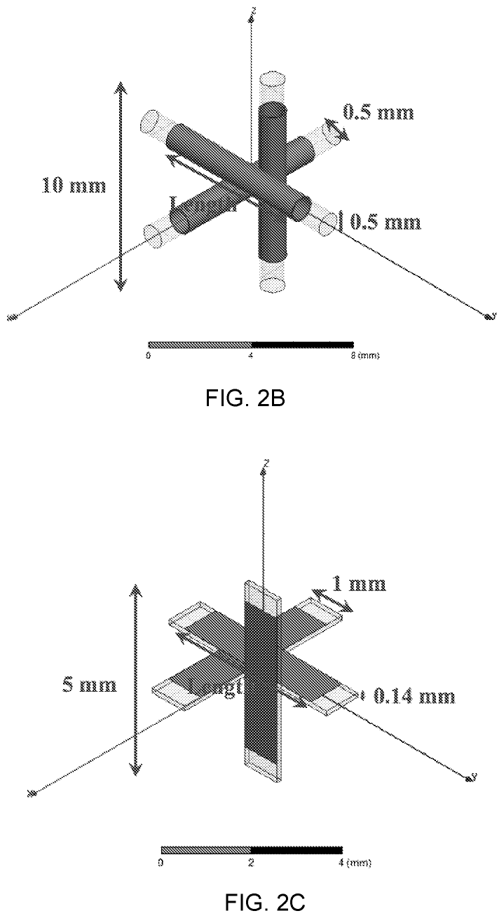

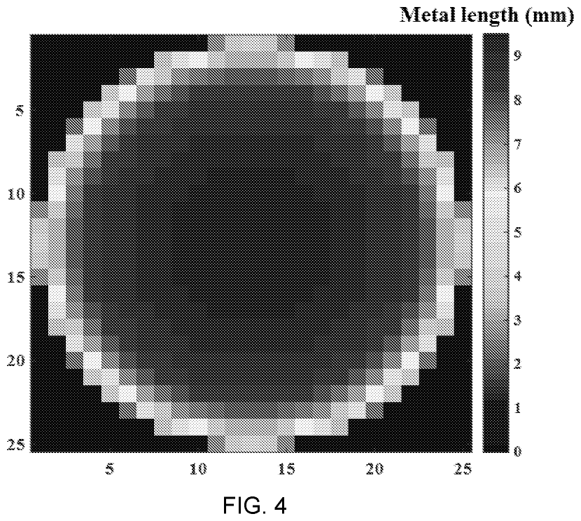

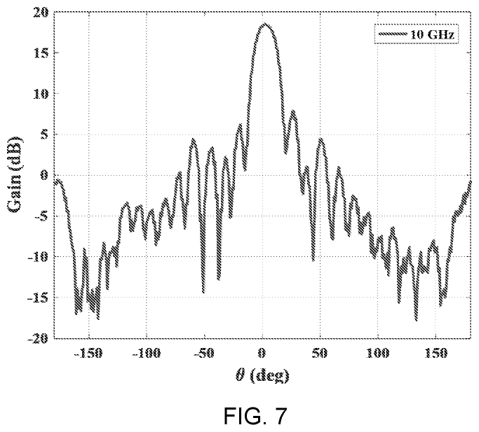

FIGS. 2A-2C show an example of a unit cell structure of various sizes for the partially-metallized string or thin film based hollow light-weight Luneburg lens structure. The effective permittivity of the unit cell was simulated by full-wave finite-element simulation software ANSYS HFSS. Darker portions represent the metallized coating and lighter portions represent the dielectric. FIG. 4 illustrates the metal length distribution for layer 0 of the unit cell of FIG. 2B. The lens is symmetric. Therefore, the distribution for layer 1 and layer −1 is the same, as is the distribution for layer 2 and layer −2, and so on. FIG. 7 shows the measured H-plane radiation of the light-weight Luneburg lens of FIG. 1B. The measured gain at 10 GHz is 18.5 dB. The measured gain at 10 GHz is 0.5 dB lower than the 3D printed Luneburg lens of FIG. 1D. The side lobe is 5 dB higher than the 3D printed Luneburg lens. The lower gain and higher side lobe may be due to the outside frame used to mount the lens.

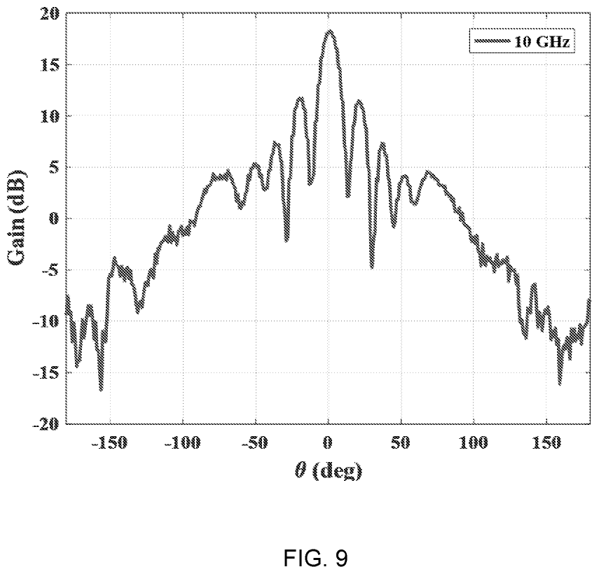

FIG. 9 shows the measured H-plane radiation of the light-weight Luneburg lens of FIG. 1B. The measured gain at 10 GHz is 18.3 dB. The side lobe in E-plane is even higher than the side lobe in H-plane, especially at 12 GHz. Removal of the frame may result in further improvement.

As used herein, the term “about” refers to plus or minus 10% of the referenced number.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be clear to those skilled in the art that modifications may be made thereto which do not exceed the scope of the appended claims. Therefore, the scope of the invention is only to be limited by the following claims. Reference numbers recited in the claims are exemplary and for ease of review by the patent office only and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A hollow structure lens (100) with radius R (102) comprising:
e) a three-dimensional scaffold (104) having multiple junctions (110); wherein each junction inside the lens is at least partially metalized (170), (180) to a degree;
f) a center point (120) of the hollow structure lens (100) formed by the three-dimensional scaffold (104); and
g) an outer edge (130) of the hollow structure lens (100) formed by the three-dimensional scaffold (104);
wherein the three-dimensional scaffold (104) forms the junctions (110) inside the lens;
wherein the junctions (110) are positioned from the innermost of the lens at or near the center point (120) toward the outermost of the lens at or near the edge (130) of the lens (100);
wherein each junction (110) resides in an imaginary unit cell (140); each imaginary unit cell is at least partially metalized to the degree of the at least partially metalized junction (170) that resides within each imaginary unit cell (140);
wherein the further the partially metalized junction (180) is away from the center point (120), the less the degree of the metallization of the imaginary cell (140).

2. The hollow structure lens (100) of claim 1, wherein the degree of the metallization of the imaginary cell can be calculated by a full-wave finite-element simulation software, to produce a permittivity of the imaginary cell being εᵣ, wherein
$${ɛ}_{r} = 2 - {( \frac{r}{R} )}^{2} ,$$
wherein r is the distance of the junction to the center point (120).

3. The hollow structure lens (100) of claim 1, wherein the at least partially metalized junction is constructed from a at least partially metalized thin film (180), thread, fiber, wire or string (190).

4. The hollow structure lens (100) of claim 1, wherein a metal etch, or an ink jet print can be used to metalize a dielectric substrates to make the partially metallized junctions (180), (190).

5. The hollow structure lens (100) of claim 1, wherein the scaffold (104) is constructed by stacking layers of the at least partially metalized thin films, wires or strings in a way that each layer crisscross to each other to produce the hollow structure lens (100).

6. The hollow structure lens (100) of claim 1, wherein the crisscross layers is fixed on to a support frame (200).

7. The hollow structure lens (100) of claim 1, wherein the support frame is 3D printed.

8. The hollow structure lens (100) of claim 1, wherein the scaffold and partially metalized junctions is constructed by interlocking at least partially metalized thin film plates (210), (220); wherein interlocking means at least 2 plates intersect with each other and form the junction (110); wherein the at least partially metalized plates forms at least partially metalized junctions when they interlock.

9. The hollow structure lens (100) of claim 1, wherein majority of the space is a free space due to 3D scaffold structure.

10. The hollow structure lens (100) of claim 1 is a Luneburg lens.

11. A method for fabricating a light-weight lens structure, operating in Radio Frequency (RF), by utilizing effective medium approximations of partially-metalized dielectric thin film, wire, threads, fiber or string, the method comprising
a) etching a series of patterns, descriptive of a continuously varying relative permittivity characteristic of the light-weight lens structure, on a series of layers of a dielectric substrate with conductive ink;
b) providing a support frame;
c) assembling the light-weight lens structure by stacking the series of layers of the dielectric substrate; and
d) securing said stacking with the set of support frames.

12. The method for fabricating a light-weight lens of claim 11, wherein the lens is a Luneburg lens.

13. A method for fabricating a light-weight Luneburg lens structure, operating in RF frequency, by utilizing effective medium approximations of partially-metalized dielectric thin film, wire, string, threads or fiber to realize a gradient index requirement of Luneburg lens structures, the method comprising constructing a set of design patterns, representative of a continuously varying relative permittivity characteristic of the light-weight Luneburg lens structure, with a plurality of partially-metallized strings, wherein each partially-metallized string comprises a metallic coating disposed on a dielectric material.
